(19) United States
(12) Patent Application Publication
(10) Pub. No.: US 2026/0153222 A1
(43) Pub. Date: Jun. 4, 2026

(54) LIGHTING SYSTEM

(71) Applicant: ERCO GmbH, Lüdenscheid (DE)

(72) Inventor: Matthias BREMERICH, Lennestadt (DE)

(21) Appl. No.: 19/320,371

(22) Filed: Sep. 5, 2025

(30) Foreign Application Priority Data
Sep. 12, 2024 (DE) 10 2024 126 258.3

(51) Int. Cl. F21V 7/06; F21W 131/107; F21Y 113/10; F21Y 115/10

(52) U.S. Cl. CPC F21V 7/06; F21V 2200/00; F21W 2131/107; F21Y 2113/10; F21Y 2115/10

(57) ABSTRACT

A system of luminaires for illuminating a building surface, including a first luminaire having a housing and a collimating optics fixed on the housing in a mounting position, wherein the collimating optics is associated with a set position for a light source, and having a printed circuit board with an LED is arranged in the set position. The LED emits light and radiates the light into the collimating optics. A second luminaire has a structurally identical housing and a structurally identical collimating optics fixed on the housing in the same mounting position, wherein the collimating optics is associated with the same set position, and has a printed circuit board and a light guide fixed relative to the printed circuit board. At least two LEDs are arranged on the printed circuit board and radiate light into the light guide. The light guide supplies the light from the two LEDs in a mixed form to a light emission surface of the light guide. The light emission surface is arranged at the set position, and the light guide radiates the mixed light from the light emission surface into the collimating optics.

The invention relates firstly to a system of luminaires according to claim 1.

The applicant has been manufacturing luminaires for illuminating building surfaces for many decades. Such luminaires are referred to as building luminaires or architecture luminaires. They can e.g. be arranged on a first building wall of a building space and illuminate a second building wall of the building space. These also include surfaces, to be illuminated, of a building, such as works of art or path surfaces. In particular, the invention relates to luminaires for homogeneously illuminating building surfaces or regions of building surfaces.

The applicant in particular manufactures luminaires which generate white light of a predetermined or predeterminable colour temperature. These luminaires can comprise one LED or a plurality of LEDs, optionally also one or more LED clusters. An LED cluster within the meaning of the present patent application is a collection of two or more LEDs which are arranged directly adjacently to one another and provide a punctiform or virtually punctiform light source.

Luminaires of the prior art, by the applicant, generally comprise a luminaire housing and a printed circuit board on which at least one LED is arranged. Each luminaire comprise a collimating optics, i.e. e.g. a collimator optics or a reflector, into which the LED radiates. In the case of a reflector, this is configured such that the desired light distribution is generated as a result of a certain reflection behaviour. The collimator optics is configured such that the desired light distribution is generated at optical interfaces as a result of a certain light refraction or total reflection behaviour. Each collimating optics is assigned an exact set position for the light source, i.e. for the LED or for the LED cluster. The LED must be arranged at a certain location in relation to the collimating optics, in order to generate the desired light distribution.

In the case of a reflector configured as a parabolic reflector, it is e.g. known to arrange the light source at the focal point of the reflector.

In the case of the collimating optics of interest in the present case, the optical interfaces, which are used for reflection or light guidance, are clearly much more complicated and complex in design, in a geometric perspective, than in the case of a parabolic reflector. The optical interfaces are freeform surfaces which are configured using complex simulation calculations.

The applicant also develops and markets luminaires in which LEDs of different types are arranged on a printed circuit board. For example, the applicant manufactures luminaires that are referred to as TW luminaires (=tunable white luminaires). In this case, at least two different LEDs are provided, which emit white light of different colour temperatures. The two LEDs can be dimmed relative to one another by means of electrical control. The sum light, i.e. the sum of the two lighting currents, can comprise white light having a variable, settable colour temperature. Thus, for example, one LED may emit cold white light of a high colour temperature, and a second LED may emit warm white light of a low colour temperature. Relative dimming of the two LEDs relative to one another makes it possible for a sum light with a desired colour temperature to be set between the two colour temperatures of the two white light LEDs.

For this purpose, good mixing of the light is required for achieving a light distribution, on the building surface to be illuminated, that is homogeneous in terms of colour. In the case of a concept of light mixing by the applicant, a light mixing box is used, which consists of a plurality of mirrored walls of an e.g. octahedron-shaped cylindrical body.

Further so-called RGB luminaires of the applicant's prior art provide that LEDs of different colours are arranged in the luminaire, e.g. a red LED, a green LED and a blue LED. These LEDs can also be dimmed relative to one another, and any desired colour location can be set as a result of electronic actuation of the LEDs and corresponding dimming.

Light mixing is desirable in the case of these RGB luminaires too, in order to achieve a homogeneous colour mixing of the light distribution on the building wall to be illuminated.

Proceeding from the described prior art, the object of the invention is that of simplifying manufacture of different luminaires which use different LED light drive.

The invention achieves this object with the features of claim 1.

According to the invention, a system is provided which comprises a first luminaire and a second luminaire. Each of the luminaires serves for illuminating a building surface. The first luminaire comprises a first housing, a first printed circuit board, a first collimating optics, in particular a reflector arrangement having at least one reflector bowl, and one LED or a plurality of LEDs. The collimating optics, which is configured for receiving the light emitted from the LED or the light emitted from the plurality of LEDs, and for light guidance and/or for reflection of the received light, serves to generate a particular light distribution. In order that the collimating optics can generate the desired light distribution, the collimating optics is assigned a set position for the at least one LED. The luminaire is thus designed such that the LED is positioned on a printed circuit board in such a way, and the printed circuit board is fixed on or relative to the housing in such a way that the LED is arranged exactly at the set position. As described at the outset, a position of this kind can be e.g. a focal point of a reflector. However, in the case of the specially shaped collimating optics, e.g. reflectors, to be considered in the present case, which comprise a freeform surface, reference is not made in the art to a focal point, but rather, within the meaning of the invention, to a set position.

It is clear that, in the event of the LED or the plurality of LEDs not being arranged exactly at the set position, owing to a changed light guiding behaviour or light reflection behaviour by the collimating optics, the desired light distribution cannot be achieved. Therefore, the exact positioning of the light source at the set position is of great importance.

The first luminaire comprises an LED and a collimating optics, or an LED cluster and a collimating optics, wherein the LED cluster comprises a plurality of LEDs. Alternatively, the first luminaire can also comprise a plurality of LEDs and a plurality of collimating optics, or a plurality of LED clusters and a plurality of collimating optics. For the event that the first luminaire comprises a plurality of collimating optics, each of the plurality of collimating optics can also be associated with its own set position for a light source, and in each case one LED or in each case a plurality of LEDs can be arranged at the plurality of set positions.

The LED arranged in the set position of the collimating optics emits light in a particular spectral range. For the event that a plurality of LEDs of the first luminaire are combined to form an LED cluster, these LEDs emit the same or a similar spectrum. Light mixing of the light emitted from the LED or from the plurality of LEDs is not required in the case of the first luminaire, before the light is supplied to the collimating optics.

The system according to the invention furthermore comprises a second luminaire. Only the combination of a first luminaire with a second luminaire provides a system according to the invention.

The second luminaire comprises a second housing and a second collimating optics. The second housing is configured exactly identically in design to the first housing, and the second collimating optics is configured exactly identically in design to the first collimating optics. Although the patent application refers to a first housing in the case of the first luminaire, and a second housing in the case of the second luminaire, it is in fact an identical housing. This applies analogously for the collimating optics, which is configured identically in the case of both luminaires. While the first collimating optics is located in a first mounting position, with respect to the first housing, the second collimating optics has exactly the same relative mounting position relative to the second housing.

Thus, with the exception of the elements that will still be described in the following, the second luminaire is configured identically or virtually identically, in any case of identical construction, to the first luminaire.

The second collimating optics has a set position which corresponds exactly to the first set position.

In contrast to the first luminaire, the second luminaire comprises a light guide. The light guide is supplied at the input side with light from an LED arrangement, which comprises at least two different LEDs. In this case, this can in particular be one LED of a second type and at least one LED of a third type, which for example both emit white light of different colour temperatures, or which emit light of different colours, e.g. red, green or blue.

The at least two LEDs are dimmable relative to one another, specifically following electronic actuation.

The light emitted from the two LEDs is radiated into the light guide, in the case of the second luminaire. The light guide transports the radiated-in light to a light emission surface. At the same time, however, the light guide mixes the radiated-in light in such a way that the light emerging from the light guide at the light emission surface is already well mixed in terms of colour. Further guidance of the light within the light guide preferably takes place by total reflection. By way of example, the light guide can be provided by a portion of a fibre optic strand. The light guide can consist in particular of a transparent plastics material. However, the invention also covers the case where the light guide is of a different construction.

A light guide within the meaning of the invention can in particular be an elongate body. This can e.g. have a circular cylindrical, but also a hexagonal or octagonal, cross-section.

A light guide within the meaning of the present application can also be formed by a box-shaped, e.g. elongate, body which comprises reflector surfaces. Such light guides, which also have a light mixing function, are known from the applicant in the prior art under the designation “light mixing box”.

The LEDs of the second type and third type are arranged on a second printed circuit board. In the different variants of the invention, which are described in the following, the second printed circuit board can be in an identical position or a different position, based on the housing of the luminaire.

A particularity of the invention is that the light emission surface of the light guide is positioned exactly at the set position of the collimating optics.

Thus, irrespective of whether LEDs are used which require light mixing, or whether LEDs are used which do not require light mixing, use can always be made of the same housing of the luminaire and of the same collimating optics of the luminaire.

The system according to the invention thus provides a modular construction system for luminaires which, using numerous identical parts—without intervention in the structural design of the luminaire being required—allows for the same light distributions to be achieved both in the case of single-colour luminaires which do not require light mixing and in the case of TW luminaires or in the case of RGB luminaires which require light mixing.

The manufacture of different types of luminaires is thus significantly simplified.

According to the invention it is no longer necessary, as in the prior art, for different housings or collimating optics to be constructed and manufactured for different types of LEDs. The first luminaire of the system according to the invention comprises a collimating optics, and the second luminaire of the system according to the invention comprises a structurally identical collimating optics.

A collimating optics within the meaning of the present patent application can be provided by a reflector bowl or by a collimator optics, or it can comprise a reflector bowl or a collimator optics. A collimating optics can also comprise a plurality of optical light-guiding elements arranged behind one another in the light path, e.g. a first reflector and a second reflector, or a first reflector and a collimator optics or a first reflector and a lens element. A collimating optics within the meaning of the present invention is an optical element that change the light distribution and in the process performs light collimating along a spatial portion, i.e. in particular refracts the light or changes, in particular reduces, the beam angle, optionally also only partially within the entire light distribution.

A collimating optics within the meaning of the invention is in any case configured for contributing to generating a focussed light distribution, proceeding from a punctiform light source, which in particular radiates light along a 180 degree solid angle range, as a result of beamforming, with the aid of optical interfaces, in particular in order to homogeneously illuminate a building wall, whether this be e.g. for the purpose of wall flooding or e.g. for the purpose of a defined radiation characteristic, such as spot, flood, wide flood, oval or the like.

According to an advantageous embodiment of the invention, the light guide is fixed on the second printed circuit board. This allows for a particularly simple construction of a second luminaire.

According to a further advantageous embodiment of the invention, the light guide is a cylindrical body consisting of transparent plastics material. This allows for conventional materials and components, which are suitable for a light guide, to be used. According to an advantageous embodiment of the invention, the first luminaire comprises at least one LED of a first type and at least one LED cluster comprising LEDs of the first type. This embodiment of the invention allows for conventional luminaires to be used. The luminaire can comprise just one LED or just one LED cluster or a plurality of LED clusters. The number of collimating optics preferably corresponds to the number of LED clusters.

According to an advantageous embodiment of the invention, the second luminaire comprises at least one LED of the second type and at least one LED of the third type, or at least one LED cluster comprising at least one LED of the second type and at least one LED of the third type, wherein the LED of the second type and the LED of the third type emit different spectral light distributions. This embodiment of the invention also allows for conventional parts and components of luminaires to be used.

According to an advantageous embodiment of the invention, at least one LED of the second type emits white light of a first colour temperature, and at least one LED of the third type emits white light of a second colour temperature different from the first colour temperature. This embodiment of the invention makes it possible to provide a modular construction system for luminaires, which comprises single-colour luminaires as well as TW luminaires or RGB luminaires.

According to an advantageous embodiment of the invention, at least one LED of the second type emits coloured light of a first colour, and at least one LED of the third type emits coloured light of a second colour that is different from the first colour. This embodiment of the invention allows for conventional principles to be used when manufacturing luminaires, and for provision of a system that can provide single-coloured luminaires as well as TW luminaires or RGB luminaires.

According to an advantageous embodiment of the invention, a first mechanical interface for fixing a first printed circuit board in a first position, and a second mechanical interface for fixing a second printed circuit board in a second position spaced apart from the first position, is arranged on the housing. This embodiment of the invention allows for particularly simple manufacture of first luminaires and of second luminaires. The housing can be configured exactly identically in the case of both luminaires. Depending on whether a luminaire of the first type or a luminaire of the second type is manufactured, the printed circuit board is fixed to the first interface or to the second interface. The fastening elements, e.g. screws, and e.g. the screwing points on the printed circuit board, or e.g. through-openings for screw fastening elements, can also be provided in identical construction in the case of the first luminaire and in the case of the second luminaire. The two mechanical interfaces can in particular be spaced apart from one another by a clearance that corresponds to the length of the light guide.

According to an advantageous embodiment of the invention, the two mechanical interfaces are spaced apart from one another by a clearance that corresponds exactly or approximately to a length of the light guide. This embodiment of the invention allows for a particularly simple construction.

According to an advantageous embodiment of the invention, a mechanical interface for fixing the printed circuit board is arranged on the housing, wherein the first printed circuit board of the first luminaire is fixed directly on the interface, and wherein the second printed circuit board of the second luminaire is fixed on the interface with the aid of an adapter. This embodiment of the invention allows for a particularly simple construction of the housing, which merely has to have one single mechanical interface. Here, an adapter, e.g. in the manner of an offset piece, can be provided, e.g. with the aid of an angle element, in order to fasten the second printed circuit board of the second luminaire on the first mechanical interface in such a way that the light guide is positioned with its light emission surface in the set position. The adapter can be of a length that corresponds approximately to the length of the light guide. The adapter can space the printed circuit board apart from the mechanical interface by a clearance that corresponds approximately to the length of the light guide.

According to an advantageous embodiment of the invention, a mechanical interface for fixing the printed circuit board is arranged on the housing. The printed circuit boards of the two luminaires can both be fixed directly on the interface. The light guide of the second luminaire is configured to be curved in an arcuate manner. This embodiment of the invention allows for a particularly simple construction. In particular, it can be provided here that the housing comprises only one mechanical interface. The light guide can comprise an arcuate portion, such that the light that is emitted from the at least two LEDs or is to be mixed is radiated into a light guide which guides the radiated-in light along the arcuate portion.

Further advantages of the system according to the invention emerge on the basis of the dependent claims (not cited) and from the following description of the embodiments shown in the drawings, in which:

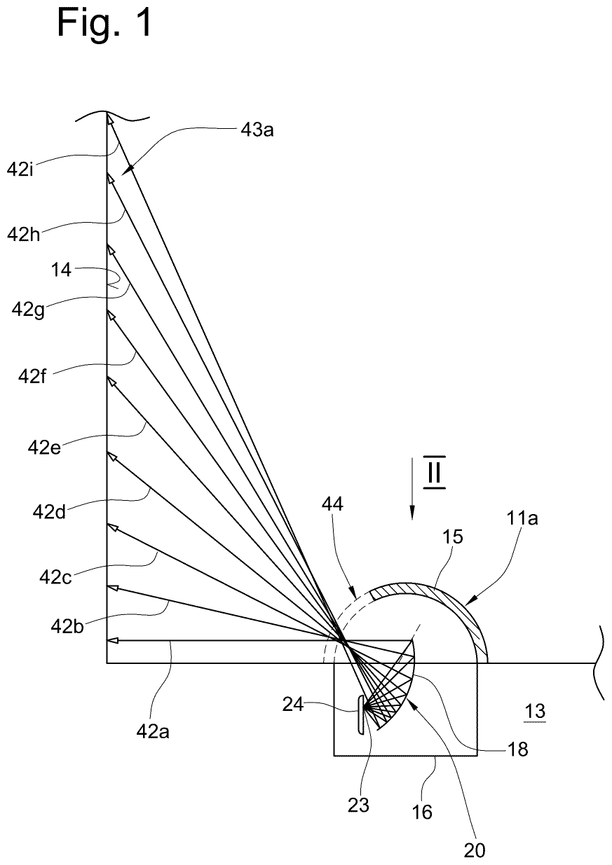

FIG. 1 is a partially sectional, schematic view of a first embodiment of a first luminaire of a system according to the invention, wherein the luminaire is configured as a ground luminaire for arrangement in an indicated base wall and serves for illuminating an indicated vertical building wall,

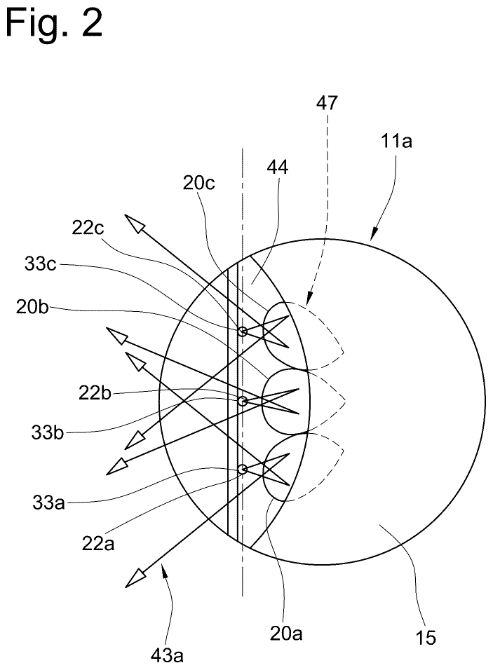

FIG. 2 is a simplified, schematic, partially sectional plan view, in isolation, of the embodiment of the first luminaire of FIG. 1, approximately according to the viewing arrow Il in FIG. 1, wherein three LEDs on the printed circuit board of the luminaire, and three collimating optics in the form of reflector bowls are indicated,

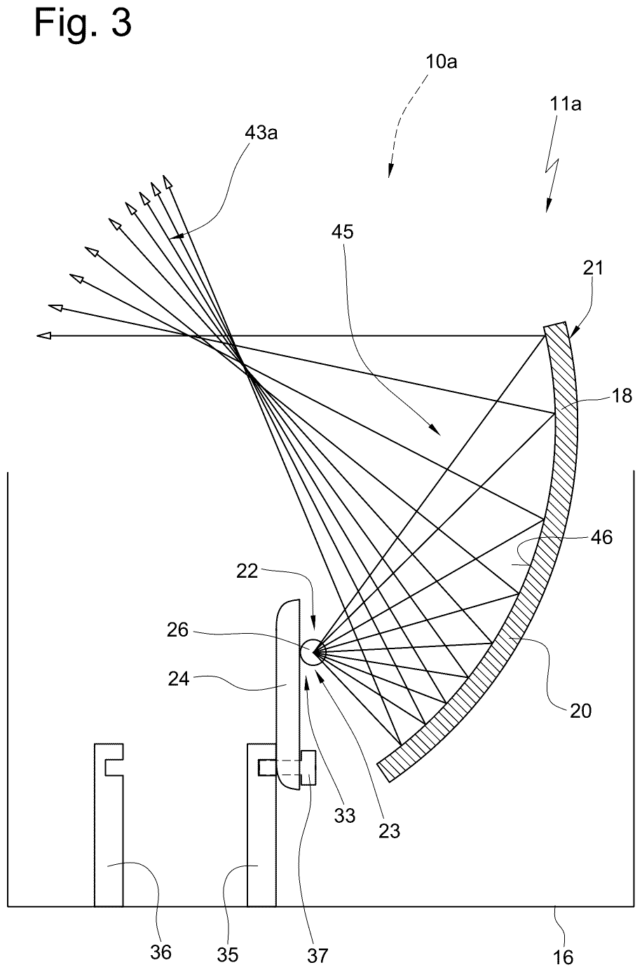

FIG. 3 is an enlarged, partially sectional, schematic view of the first luminaire of FIG. 1, illustrating additional structural details of the luminaire, wherein the luminaire comprises a first printed circuit board which is arranged in a first position on a first mechanical interface,

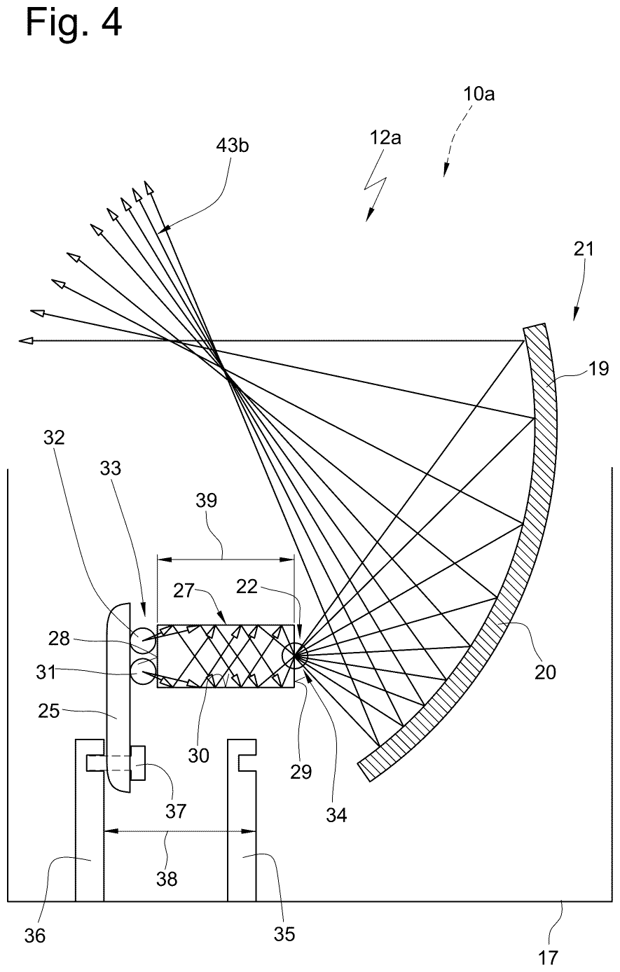

FIG. 4 shows an embodiment of a second luminaire in an illustration according to FIG. 3, wherein the first luminaire of FIG. 3 and the second luminaire of FIG. 4 together provide a first embodiment of a system according to the invention,

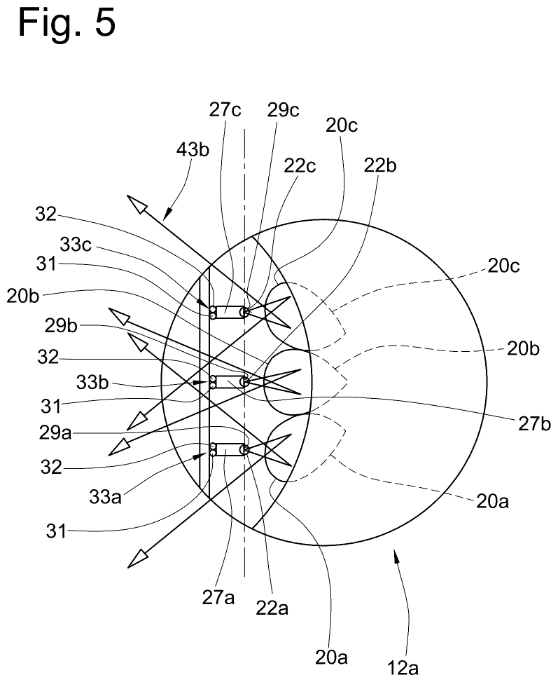

FIG. 5 shows the embodiment of the second luminaire according to FIG. 4 in a view according to FIG. 2,

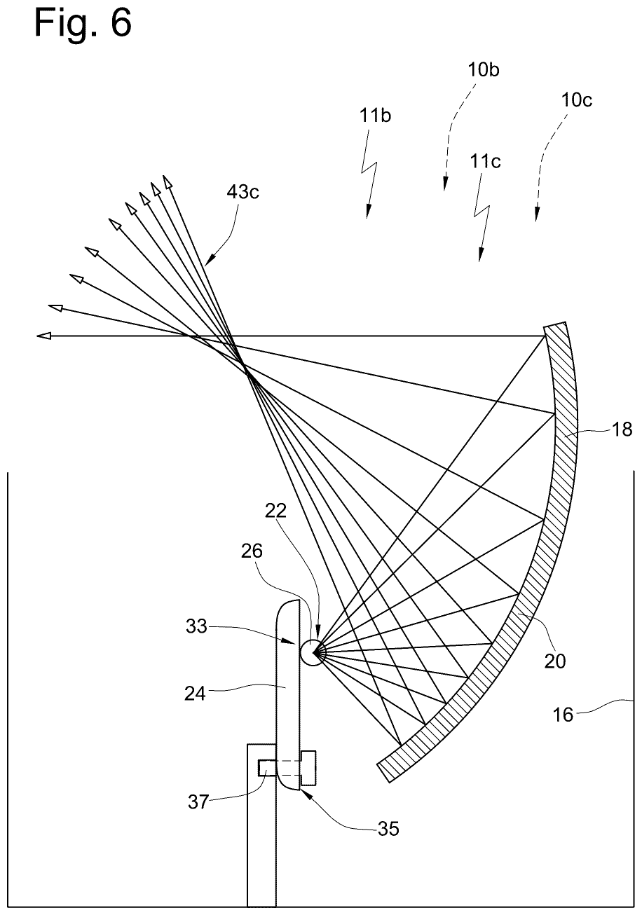

FIG. 6 shows a further embodiment of a first luminaire in an illustration according to FIG. 3, wherein the luminaire of FIG. 6 has merely one mechanical interface for fixing a printed circuit board relative to the housing,

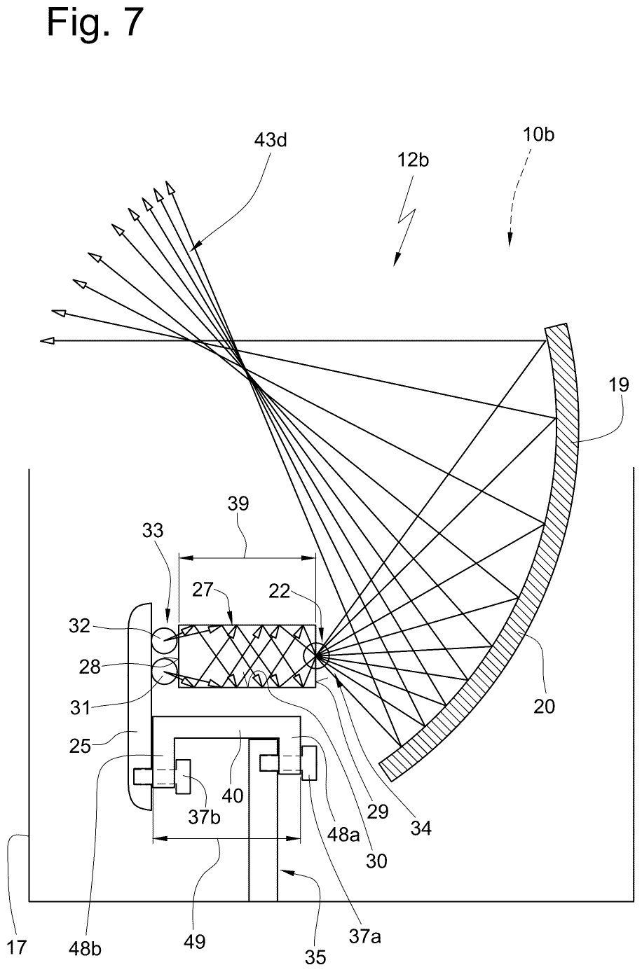

FIG. 7 shows a further embodiment of a second luminaire in an illustration according to FIG. 6, wherein the luminaire comprises a light guide and an adapter, wherein the first luminaire of FIG. 6 and the second luminaire of FIG. 7 together provide a further embodiment of a system according to the invention,

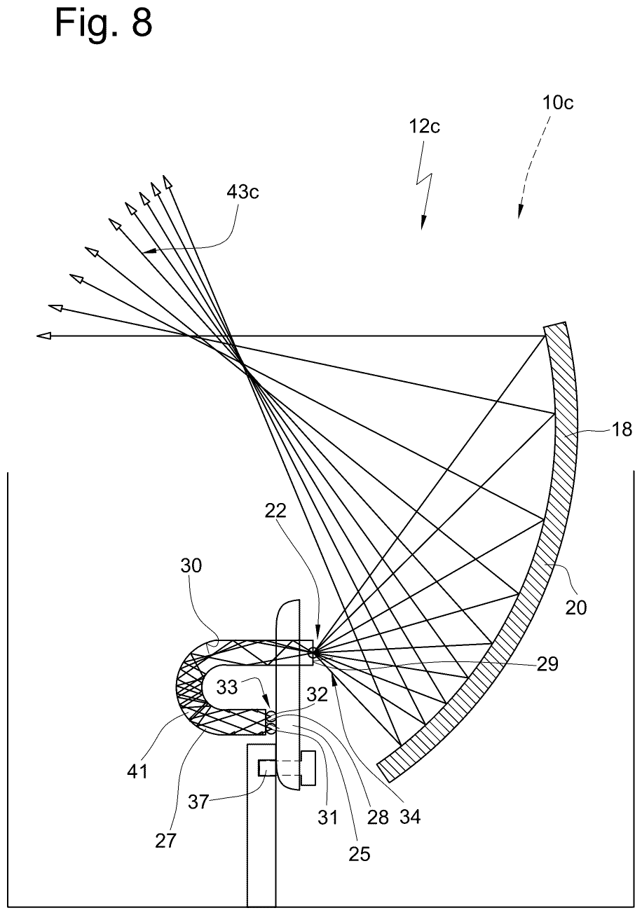

FIG. 8 shows a further embodiment of a second luminaire in an illustration according to FIG. 6, with a light guide which comprises a portion that is curved in an arcuate manner, wherein the embodiment of the first luminaire according to FIG. 6 together with the embodiment of the second luminaire according to FIG. 8 provide a third embodiment of a system according to the invention,

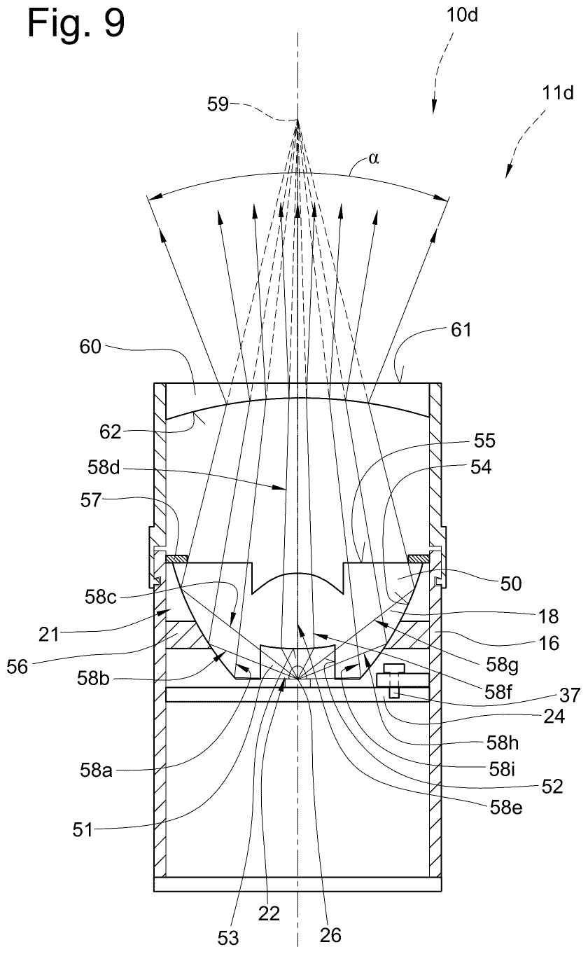

FIG. 9 shows a further embodiment of a first luminaire of a system according to the invention, in an illustration according to FIG. 3, in which the collimating optics is provided by a collimator optics, and

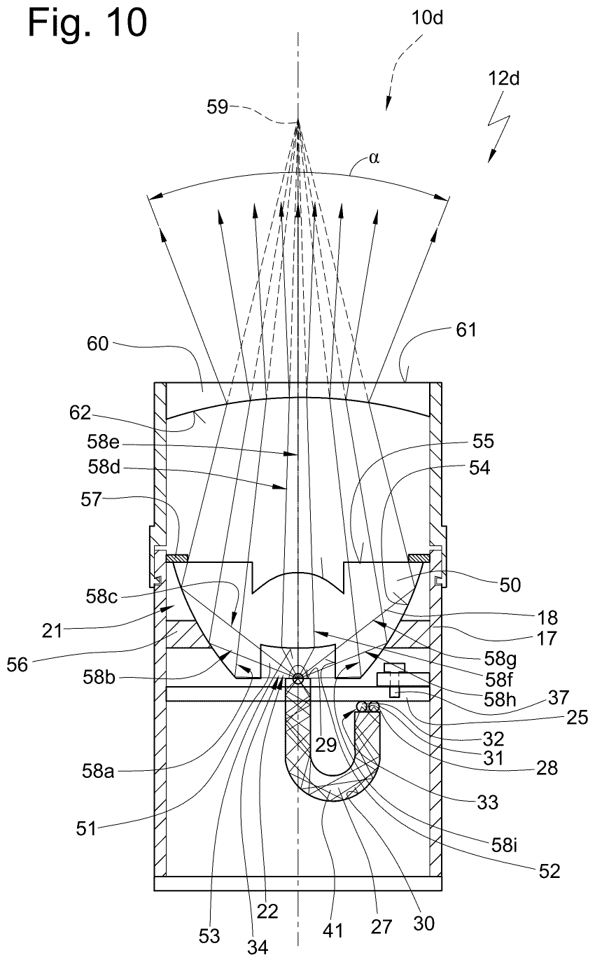

FIG. 10 shows a further embodiment of a second luminaire in an illustration according to FIG. 9, wherein the second luminaire comprises a light guide, and wherein the first luminaire of FIG. 9 and the second luminaire of FIG. 10 together provide a further embodiment of a system according to the invention.

The embodiments of the invention will be explained on the basis of the following description of the drawings:

Embodiments of the invention are described by way of example in the following description of the figures, also with reference to the drawings. In this case, for the sake of clarity-also insofar as different embodiments are concerned-identical or similar parts or elements or regions are denoted by the same reference signs, sometimes with the addition of lower-case letters.

Features that are described only with reference to one embodiment can also be provided, within the context of the invention, in any other embodiment of the invention. Embodiments amended in this way—even if they are not shown in the drawings—are also covered by the invention.

All the disclosed features are, per se, essential to the invention. The disclosure content of the associated priority documents (copy of the prior application) and the cited documents and the described devices of the prior art are hereby also incorporated in their entirety into the disclosure of the application, also for the purpose of also incorporating individual or multiple features of these documents into one or more claims of the present application.

In the drawings, embodiments of a system according to the invention are denoted in their entirety with the reference signs 10a, 10b, 10c and 10d.

A system 10a, 10b, 10c and 10d according to the invention in each case comprises a first luminaire 11a, 11b, 11c, 11d and a second luminaire 12a, 12b, 12c, 12d.

Only a combination of in each case a first luminaire 11a, 11b, 11c and 11d with a second luminaire 12a, 12b, 12c, 12d provides a system 10a, 10b, 10c, 10d according to the invention.

A first embodiment for a first luminaire 11a is explained with reference to FIG. 1-3. In the embodiment according to FIG. 1-3, the first luminaire 11a is configured as a ground recessed luminaire and for this purpose is inserted into a base wall 13 of a building space. FIG. 1 shows the mounting position of the first luminaire 11a.

The first luminaire 11a comprises a first luminaire housing 16, a first collimating optics 18, a light source 23, and a first printed circuit board 24. According to FIG. 1, the first luminaire 11a is overlapped by a cover 15, which is configured to be dome-shaped and protrudes out of the base wall 13. The cover 15 comprises a window 44, through which the light emitted from the light source 23 and reflected at a collimating optics 18 in the form of a reflector 20 can emerge. The luminaire 11a according to FIG. 1 serves for illuminating a vertical wall 14. A desired light distribution is intended to be generated on said wall 14 to be illuminated.

For clarification, it is noted that the principle according to the invention can be applied not only in the case of ground recessed luminaires, but rather also in the case of surface-mounted ground luminaires, in recessed ceiling luminaires or in surface-mounted ceiling luminaires, or in luminaires to be applied in other ways, e.g. also in the case of spotlight luminaires. The invention also covers luminaires which manage without a dome-shaped cover 15. The invention relates very generally to luminaires that comprise a collimating optics.

In the embodiments of FIG. 1-8, the collimating optics 18, 19 is formed in each case by a reflector. The invention also covers embodiments, e.g. according to FIGS. 9 and 10, in which the collimating optics 18, 19 is provided by a collimator optics 50.

The reflector 20 is configured to be shell-shaped in each of the embodiments of FIG. 1-8.

Taking into account FIG. 3 it is clear that, proceeding from an LED 26 of the first type, a light beam pencil is emitted which radiates into the interior 45 of the reflector 20. The reflector 20 is configured to be shell-shaped and comprises a highly reflective or highly mirrored surface 46, on which the light beams emitted from the LED 26 can be reflected virtually without loss. The surface 46 of the reflector bowl 20 is configured in such a way that, as a result of the reflection thereon, the desired light distribution 43a (FIG. 1) on the building wall 14 to be illuminated is achieved. This is achieved by a corresponding design of the reflector surface 46.

FIG. 3 shows only the curvature along a vertically oriented sectional plane.

In fact, the inner surface 46 of the reflector 18 is a freeform surface which can be configured to be curved in multiple respects and in multiple directions.

In the embodiment of FIG. 1-3, the first luminaire 11a, as FIG. 2 shows, comprises a reflector arrangement 47 that comprises three reflector bowls 20a, 20b, 20c.

In FIGS. 1 and 3, for the sake of clarity in each case only one reflector bowl 20 is shown.

The invention comprises embodiments of first luminaires 11 and also embodiments of second luminaires 12 which each comprise only one collimating optics, in particular a reflector bowl 20, but also those embodiments that comprise a plurality of collimating optics 18, in particular a plurality of reflector bowls 20a, 20b, 20c. Advantageously, an embodiment of a first luminaire 11 and a corresponding embodiment of a second luminaire 12 can each comprise a reflector arrangement 47 having a number of reflector bowls 20a, 20b, 20c that corresponds to the number of LED clusters 33a, 33b, 33c.

For the event that a first luminaire 11a, 11b, 11c, 11d according to the invention and a second luminaire 12a, 12b, 12c, 12d according to the invention each comprise a plurality of LED clusters and a plurality of collimating optics, it is preferably the case that each collimating optics receives only light, or substantially only light, that is emitted from an associated LED cluster. Furthermore, it is the case that light that is emitted from one of the plurality of LED clusters also radiates exclusively or largely exclusively only into one collimating optics.

FIG. 1-3 make it clear that the first collimating optics 18 is fixed relative to the housing 16, in a defined mounting position 21.

The collimating optics 18 is also, which is not shown in the figures, directly or indirectly rigidly connected to the housing 16, such that the collimating optics 18 assumes a defined set position 21 relative to the housing 16.

As a result of complex simulation calculations, the collimating optics 18 is configured in such a way that, assuming a certain position of a light source 23, the topography of the surface 46 is calculated exactly, in order to achieve a desired light distribution 43a. The collimating optics 18 is thus associated with a certain defined set position 22 for the light source 23. The light source 23 must be arranged exactly at this set position 22, in order to achieve the light beam course, indicated schematically in FIG. 1-3, with the light beams 42a, 42b, 42c, 42d, 42e, 42f, 42g, 42h, 42i, which indicates the desired light distribution 43a on the wall 14 to be illuminated.

The first luminaire 11a according to FIG. 1-3 comprises, as a component of a LED cluster 33a, 33b, 33c, a single LED 26 of the first type or a plurality of LEDs 26 of the first type. For the event that a plurality of LEDs 26 of the first type is provided as a component of an LED cluster 33a, 33b, 33c in an embodiment of a first luminaire, said plurality of LEDs 26 of the first type emit an identical or very similar light spectrum. What is decisive is that the light emitted from the LED 26 of the first type or from the plurality of LEDs 26 of the first type does not have to be pre-mixed before it is supplied to the collimating optics 18, but rather the emitted light, as FIG. 3 shows, can be radiated directly into the collimating optics 18.

FIG. 3 makes clear that a first mechanical interface 35 is arranged at the first housing 16, on which interface the first printed circuit board 24 can be fixed with the aid of a schematically indicated fastening means, e.g. in the form of a screw 37. The first mechanical interface 35 is thus the retainer shown in FIG. 3 that allows for direct fixing of the first printed circuit board 24 directly on the housing 16 or relative to the housing 16.

As a result of the fixing of the first printed circuit board 24 with the LED 26 of the first type arranged thereon, the LED 26 of the first type is arranged exactly at the set position 22.

After fastening of the first printed circuit board 24 on the housing 16, the light distribution shown in FIG. 1-3 can be generated by the first luminaire 11a.

FIG. 3 makes it clear that the first housing 16 has a second mechanical interface 36. This is not used in the case of the first luminaire 11a, according to FIG. 3. The use of this second mechanical 36 will now be explained with reference to FIG. 4:

FIGS. 4 and 5 show, in an illustration comparable to FIGS. 2 and 3, a first embodiment of a second luminaire 12a of a first embodiment of a system 10a according to the invention.

Compared with the first luminaire 11a according to FIG. 3, the second luminaire 12a according to FIG. 4 comprises a second housing 17 which is structurally identical to the first housing 16. The second housing 17 in particular has exactly identical dimensions to the first housing 16.

Furthermore, the second luminaire 12a, according to FIG. 4, comprises a second collimating optics 19 which is structurally identical to the first collimating optics 18 of the first luminaire 10a according to FIG. 1-3. The second collimating optics 19 in particular has identical dimensions to the first collimating optics 18.

The collimating optics 19 of the second luminaire 12a is also arranged exactly at the same mounting position 21 relative to the housing 17 as the first collimating optics 18 relative to the first housing 16.

The second luminaire 12a, according to FIG. 4, uses a plurality of identical parts compared with the first luminaire 11a of FIG. 3.

The differences between the second luminaire 12a according to FIG. 4 and the first luminaire 11a according to FIG. 3 are explained as follows:

According to FIG. 4, the second luminaire 12a comprises an LED cluster 33 which comprises at least two LEDs 31, 32, specifically at least one LED 31 of the second type and at least one LED 32 of the third type. The LED 31 of the second type is for example a white light-emitting LED 31 which emits light of a first colour temperature.

The LED 32 of the third type is for example an LED that emits white light of a different colour temperature.

In the case of the second luminaire 12a, the light emitted from the two LEDs 31, 32 is mixed, with the aid of a light guide 27.

The light guide 27 is for example a transparent plastics cylinder, in the manner of a portion of a fibre optic cable. The light guide 27 in particular comprises a light inlet surface 28, a light emission surface 29, and a total reflection surface 30.

The light emitted from the two LEDs 31, 32 is coupled into the light guide 27 via the light inlet surface 28 and undergoes in particular multiple total reflection at the inner wall of the light guide 27. As is indicated merely schematically in FIG. 4, as a result of the multiple total reflections the light is well mixed in terms of colour and coupled out at the light emission surface 29.

The particularity of the second luminaire 12a according to FIG. 4 is that the light emission surface 29 of the light guide 27 is positioned exactly at the set position 22 of the second collimating optics 19, which corresponds to the set position 22 of the first collimating optics 18.

Thus, the second luminaire 12a can be of exactly the same design as the first luminaire 11a, specifically have an identical housing 17, 16 and an identical collimating optics 18, 19. This thus allows for numerous identical parts to be used.

At the same time, in the case of a luminaire 11a having an LED drive 26 that does not require any light mixing and with an identically designed luminaire 12a according to FIG. 4 having an LED light drive 33 that requires light mixing, despite the use of numerous identical parts an identical light distribution 43b is achieved, which corresponds to the light distribution 43a.

The light guide 27 has an axial length 39.

The positioning of the light emission surface 29 of the light guide 27 is achieved in that a second printed circuit board 25 is fastened to the second mechanical interface 36 with the aid of preferably identical or structurally identical fastening means 37. The second mechanical interface 36 is spaced apart from the first mechanical interface 35, in particular at a clearance 38 that corresponds exactly or approximately to the length 39 of the light guide 27.

The light guide 27 emits light 34 at the light emission surface 39 that is already well mixed in terms of colour.

The fact that the light emission surface 29 is arranged exactly at the set position 22 means that the same collimating optics 19 can be used, for the light that is mixed in terms of colour, provided by the light guide 27, as in the case of the first luminaire 11a. The light beam course which is used in the case of the second luminaire 12a according to FIG. 4 corresponds approximately or exactly to the light beam course of the first luminaire 11a according to FIG. 3.

In this case a second light distribution 43b, according to FIG. 4, can be achieved using an LED cluster 33a, 33b, 33c with different coloured LEDs 31, 32, which light distribution corresponds or substantially corresponds or is approximated to the light distribution 43a of the first luminaire, approximately according to FIG. 1-3.

In this way, owing to a combination of a first luminaire 11a, according to FIG. 3, and a second luminaire 12a, according to FIG. 4, a system 10a can be provided according to the invention, which system allows for the use of numerous identical parts for different LED light drives and in this way simplifies the luminaire construction.

Only two different mechanical interfaces 35, 36 have to be provided on the luminaire housing 16, 17, which interfaces allow for different fastening positions of printed circuit boards 24, 25 and ensure that the light is always emitted at the same set position 22. This facilitates the production and manufacture, but at the same time also the construction, of luminaires.

The first luminaire 11a and the second luminaire 12a can furthermore comprise a plurality of identical parts (not shown in the figures).

The embodiment of FIG. 1-3 comprises three LED clusters 33a, 33b, 33c each having one LED 26 or each having a plurality of LEDs 26.

FIG. 5 makes it clear that the second luminaire 12a can also comprise three LED clusters 33a, 33b, 33c, wherein each of the LED clusters 33a, 33b, 33c comprises at least one LED 31 of the second type and one LED 32 of the third type.

The second luminaire 12a preferably comprises a number of LED clusters 33a, 33b, 33c that corresponds to the number of the LED clusters 33a, 33b, 33c of the first luminaire 11a.

Similarly, FIG. 5 makes it clear that the invention covers systems 10a, 10b, 10c, 10d in which the second luminaire 12a comprises a plurality of light guides 27a, 27b, 27c.

FIG. 5 also makes it clear that each of the plurality of reflector bowls 20a, 20b, 20c is associated with its own set position 22a, 22b, 22c.

A second embodiment 10b of a system according to the invention will be explained on the basis of an overview of FIGS. 6 and 7:

The system 10b comprises a first luminaire 11b, according to FIG. 6, and a second luminaire 12b, according to FIG. 7.

The first luminaire 11b according to FIG. 6 substantially corresponds to the first luminaire 11a according to FIG. 3, with the difference that only one mechanical interface 35 is provided.

The second interface 36 of the first luminaire, according to FIG. 3, can be omitted in the case of the first luminaire 11b, according to FIG. 6. Furthermore, the first luminaire 11b, according to FIG. 6, is configured identically to the first luminaire 11a, according to FIG. 3.

The second luminaire 12b corresponds, in terms of lighting technology, to the second luminaire 12a, according to FIG. 4:

Here, however, in contrast to the second luminaire 12a, fastening of the printed circuit board 25 is not provided directly on the mechanical interface 35, but rather with the aid of an adapter 40.

The adapter 40 can comprise a first fastening end 48a, with which it is fixed to the mechanical interface 35 with the aid of a first fastening means 37a, and a second fastening end 48b, with which it is fixed to the printed circuit board 25, with the aid of a second fastening means 37b.

The adapter 40 can be of an axial length 49 that corresponds approximately or exactly to the axial length 39 of the light guide 27.

In turn, both in the case of the first luminaire 11b, according to FIG. 6, and in the case of the second luminaire 12b, according to FIG. 7, positioning of the LED 26 at the set position 22 or positioning of the light emission surface 29 of the light guide 27 at the same set position 22 can be achieved. Thus, in this embodiment of a system 10b, too, a light distribution 43d of the second luminaire 12b, which corresponds to a light distribution 43c of the first luminaire 11b, can be achieved using numerous identical parts, such as housing 16, 17 and collimating optics 18, 19, for different LED light drives.

In turn, also in this embodiment of a system, a plurality of LED clusters 33a, 33b, 33c can be provided in the case of the first luminaire 11b and in the case of the second luminaire 12b, wherein the number of the LED clusters 33a, 33b, 33c of the second luminaire 12b corresponds to the number of the LED clusters 33a, 33b, 33c of the first luminaire 11b.

A further embodiment of a system 10c according to the invention is explained in overview of FIGS. 6 and 8. This comprises a first luminaire 11c, according to FIG. 6, and a second luminaire 12c, according to FIG. 8.

The first luminaire 11c corresponds to the first luminaire 11b explained above.

The second luminaire 12c comprises a printed circuit board 25, on which an LED cluster 33 comprising an LED 31 of the second type and an LED 32 of the third type are arranged. In contrast with the first luminaire 11c, the LEDs are arranged on the opposite side of the printed circuit board 25. In turn, the LED 31 of the second type emits light of a first colour or white light of a first colour temperature, and the LED 32 of the third type emits light of a second colour or white light of a different colour temperature.

A light guide 27 is provided here, which is configured to be substantially curved-in the manner of a U.

The light guide 27, curved in an arcuate manner, comprises a light inlet surface 28 and a light emission surface 29. The light is supplied, thoroughly mixed in terms of colour, to the light emission surface 29 via an arcuate portion 41 with the aid of total reflection surfaces 30. Said light emission surface is in turn arranged at the set position 22 of the collimating optics 18. Here, too, an identical housing 16 and an identical collimating optics 18a and numerous further identical components can therefore be used. For the construction of the two luminaires 11c, 12c, it is merely necessary to make use of amended printed circuit boards and an amended positioning of the LEDs 31, 32.

A further embodiment of a system 10d according to the invention, of the invention, is shown by the combination of a first luminaire 11d, according to FIG. 9, with a second luminaire 12d, according to FIG. 10.

It is clear from FIG. 9 that the first luminaire 11d in turn comprises a luminaire housing 16, which is shown merely schematically. Here, the luminaire 11d is configured not as a recessed luminaire but rather as a spotlight luminaire. For reasons of clarity, only the luminaire housing is shown, without the mechanical connection and—as in the embodiments of FIG. 1 to 8—without the electrical power supply lines and control lines, and without the electrical and electronic components and mains connections, and other essentially provided electronic components which are required in the case of conventional luminaires. A collimator optics 50 is arranged, as the first collimating optics 18, on the luminaire housing 16.

The collimator optics 50 comprises a cavity 51 into which the LED 26 of the first type radiates light.

The cavity comprises side wall portions 52 and a cover wall portion 53.

Furthermore, the collimator optics 50 comprises total reflection surfaces 54 and a light emission surface 55.

In the embodiment of FIG. 9, the collimator optics 50 is configured such that collimating of all the light beams emitted by the LED 26 of the first type takes place approximately in an imaginary focal point or focus region 59.

However, the luminaire 11d additionally also comprises a diverging lens 60 having a planar light emission surface 61 and a slightly convexly curved light inlet surface 62.

The diverging lens 60 leads to spreading of the incident light, such that a beam angle a is achieved.

The light beams 58a to 58h illustrate the light guidance which is generated by the collimator optics 50, as the first collimating optics 18, and by the diverging lens 60.

The luminaire 11d, according to FIG. 9, thus provides a desired light distribution. The collimator optics 50, the housing 16, and also the diverging lens 60 are configured such that the desired light distribution is achieved.

The printed circuit board 24, which is shown schematically, is fixed directly on the housing 16.

In the embodiment of FIG. 9, the collimator optics 50 is fixed rigidly relative to the housing 16, in a set position 21, with the aid of a retainer seat 56 that is rigidly connected to the housing 16, and a retaining ring 57 provided separately therefrom.

FIG. 10 illustrates the embodiment of a second luminaire 12d.

The second luminaire 12d comprises a printed circuit board 25, a light guide 27, and an LED cluster 33 having an LED 31 of the second type and an LED 32 of the third type. The light guide 27 comprises a light emission surface 29 which is arranged exactly at the same set position 22 as the LED 26 of the first type in the case of the luminaire 11d, according to FIG. 9. The luminaire 12d can thus make use of numerous identical parts.

From a direct comparison of FIGS. 9 and 10 it is clear that the second housing 17 of the second luminaire 12d is structurally identical to the first housing 16 of the first luminaire 11d. It is furthermore clear that the collimator optics 50 of the second luminaire 12d, including the mechanical fastening elements, such as the retaining ring 57 and retainer seat 56, are configured identically to the collimator optics 50 of the first luminaire 11d.

Thus, an identical luminaire construction can again be used. Only the LED light drive and the printed circuit board are different.

Here, too, use can be made of a single mechanical interface for fastening the printed circuit board 24, 25 on the housing 16, 17.

The luminaire 11d, according to FIG. 9, and the luminaire 12d, according to FIG. 10, together form an embodiment of a system 10d according to the invention.

1-12. (canceled)

13. A system of luminaires for illuminating a building surface, comprising: a first luminaire having a housing and having a collimating optics, the first luminaire being fixed on the housing in a mounting position, wherein the collimating optics is associated with a set position for a light source, and having a printed circuit board on which at least one LED is arranged in the set position, wherein the LED emits light from the set position and radiates said light into the collimating optics; and a second luminaire having a structurally identical housing and having a structurally identical collimating optics, the second luminaire being fixed on the housing in the same mounting position, wherein the collimating optics is associated with the same set position, and having a printed circuit board and having a light guide that is fixed relative to the printed circuit board, wherein at least two LEDs are arranged on the printed circuit board, which LEDs radiate their light into the light guide, wherein the light guide supplies the light, emitted from the two LEDS, in a mixed form to a light emission surface of the light guide, wherein the light emission surface is arranged at the set position, and wherein the light guide radiates the mixed light from the light emission surface into the collimating optics.

14. The system according to claim 13, wherein the light guide is fixed on the printed circuit board.

15. The system according to claim 13, wherein the light guide is an elongate body consisting of transparent plastics material.

16. The system according to claim 13, wherein the first luminaire comprises at least one LED of the first type or at least one LED cluster with LEDs of the first type.

17. The system according to claim 13, wherein the second luminaire comprises at least one LED of the second type and at least one LED of the third type, or at least one LED cluster comprising at least one LED of the second type and at least one LED of the third type, wherein the LED of the second type and the LED of the third type emit different spectral light distributions.

18. The system according to claim 17, wherein at least one LED of the second type emits white light of a first color temperature, and at least one LED of the third type emits white light of a second color temperature different from the first color temperature.

19. The system according to claim 17, wherein at least one LED of the second type emits colored light of a first color, and at least one LED of the third type emits colored light of a second color different from the first color.

20. The system according to claim 13, wherein a first mechanical interface is arranged on the housing for fixing the first printed circuit board in a first position, and a second mechanical interface for fixing the printed circuit board in a second position spaced apart from the first position.

21. The system according to claim 20, wherein the two mechanical interfaces are spaced apart from one another by a clearance which corresponds exactly or approximately to a length of the light guide.

22. The system according to claim 13, wherein a mechanical interface is arranged on the housing for fixing the printed circuit board, wherein the printed circuit board of the first luminaire is fixed directly on the interface, and wherein the printed circuit board of the second luminaire is fixed on the interface with the aid of an adapter.

23. The system according to claim 13, wherein a mechanical interface is arranged on the housing for fixing the printed circuit board, wherein the printed circuit boards of the two luminaires are in each case fixed directly on the interface, wherein the light guide of the second luminaire is curved in an arcuate manner.

24. The system according to claim 13, wherein the first luminaire comprises a plurality of LED clusters and the second luminaire comprises a plurality of LED clusters and a plurality of light guides.

25. The system according to claim 13, wherein the collimating optics is a reflector bowl.

26. The system according to claim 25, wherein the collimating optics of the second luminaire is a reflector bowl which is structurally identical to the reflector bowl of the first luminaire.

27. The system according to claim 15, wherein the body is cylindrical.
